(19) United States
(12) Patent Application Publication
(10) Pub. No.: US 2026/0303824 A1
(43) Pub. Date: Oct. 1, 2026

(54) IMAGE ENCODING APPARATUS AND METHOD, IMAGE DECODING APPARATUS AND METHOD, AND STORAGE MEDIUM

(71) Applicant: CANON KABUSHIKI KAISHA, Tokyo (JP)

(72) Inventors: YUSHI KANEKO, Kanagawa (JP); SUSUMU IGARASHI, Kanagawa (JP)

(21) Appl. No.: 19/577,710

(22) Filed: Mar. 25, 2026

(30) Foreign Application Priority Data
Mar. 31, 2025 (JP) 2025-059132
Mar. 31, 2025 (JP) 2025-059133

(51) Int. Cl. H04N 19/14; H04N 19/176; H04N 19/182

(52) U.S. Cl. CPC H04N 19/14; H04N 19/176; H04N 19/182

(57) ABSTRACT

An image encoding apparatus that encodes image data for each block composed of a predetermined number of pixels, generates coded data having a preset target code size, and outputs the coded data, the apparatus comprises: an acquisition unit that acquires image data; an encoding unit that encodes, for each block, the acquired image data such that a block code length of coded data for each block does not exceed the target code size; a determination unit that randomly determines priorities of the pixels constituting each block; and an addition unit that, if the block code length of each block is less than the target code size, adds to the coded data, lost bits of pixels lost through the encoding, in order from the pixel with a highest priority and without exceeding the target code size.

### BACKGROUND

### Field of the Technology

The present disclosure relates to an image encoding apparatus and method, an image decoding apparatus and method, and a storage medium, and more particularly to image encoding and decoding techniques.

### Description of the Related Art

In recent years, with the trend toward higher resolutions and higher frame rates in image capturing apparatuses such as digital video cameras, the amount of image data handled per unit time by the apparatus has increased significantly. This has led to demands for faster image memory and faster bus interface circuits within the apparatus. On the other hand, to cope with the increased amount of image data, compression coding of images has been considered upstream and downstream of the image memory and bus interface. In other words, by reducing the amount of data per unit time on the bus interface, the demand for faster circuits can be alleviated.

In this case, it is desirable for the coding method for compression coding to have a small circuit scale and small coding delay, and conventional DCT-based coding methods such as JPEG and MPEG2 are unsuitable for this purpose. Therefore, compression coding using a Differential Pulse Code Modulation (DPCM) based predictive coding method has been proposed (Japanese Patent Laid-Open No. 2010-004514 and Japanese Patent Laid-Open No. 2016-213528).

In this case, in an image in which random noise appears, such as a dark image containing dark current noise, it is desirable that the noise be reproduced randomly even after encoding and decoding. However, there are cases in which the randomness of the noise is lost after encoding and decoding, and the noise is sometimes reproduced as unnatural stripes.

### SUMMARY

The present disclosure has been made in consideration of the above situation, and maintains the randomness of noise in an image generated by decoding.

According to the present disclosure, provided is an image encoding apparatus that encodes image data for each block composed of a predetermined number of pixels, generates coded data having a preset target code size, and outputs the coded data, the apparatus comprising one or more processors and/or circuitry which function as: an acquisition unit that acquires image data; an encoding unit that encodes, for each block, the image data acquired by the acquisition unit such that a block code length of coded data for each block obtained through the encoding is equal to or less than the target code size; a determination unit that randomly determines priorities of the pixels constituting each block; and an addition unit that, in a case where the block code length of each block generated by the encoding unit is less than the target code size, adds to the coded data, a lost bit or bits of each pixel that were lost through the encoding, in order from the pixel with a highest priority and without exceeding the target code size.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram illustrating a schematic configuration of an image processing apparatus according to an embodiment of the present disclosure.

FIG. 2 is a block diagram illustrating a configuration of an image encoding unit according to a first embodiment.

FIG. 3 is a block diagram illustrating a detailed configuration of an encoding unit according to the first embodiment.

FIG. 4 is a block diagram illustrating a configuration of an image decoding unit according to the first embodiment.

FIGS. 5A to 5C are diagrams illustrating examples of formats of image data to be encoded according to the first embodiment.

FIGS. 6A to 6D are diagrams for explaining quantized data and lost bits according to the first embodiment.

FIG. 7 is a flowchart of the processing for determining an encoding mode to be employed and a QP to be employed according to the first embodiment.

FIG. 8 is a flowchart illustrating details of a process in step S704 in FIG. 7.

FIGS. 9A and 9B are diagrams illustrating specific examples of the relationship between block code lengths and degradation levels.

FIGS. 10A and 10B are diagrams illustrating examples of priority patterns output from a lost bit priority determination unit according to the first embodiment.

FIG. 11A is a diagram illustrating a first example configuration of a pseudorandom value generation circuit used in the lost bit priority determination unit according to the first embodiment.

FIG. 11B is a diagram illustrating a second example configuration of a pseudorandom value generation circuit used in the lost bit priority determination unit according to the first embodiment.

FIG. 11C is a diagram illustrating a third example configuration of a pseudorandom value generation circuit used in the lost bit priority determination unit according to the first embodiment.

FIG. 12 is a diagram illustrating a format of coded data in DPCM mode according to the first embodiment.

FIGS. 13A and 13B are diagrams for explaining a method of storing lost bits according to the first embodiment.

FIG. 14 is a diagram illustrating the format of coded data in PCM mode according to the first embodiment.

FIG. 15 is a flowchart illustrating a method of determining a number of lost bits to be stored by a multiplexing unit according to the first embodiment.

FIG. 16 is a flowchart illustrating inverse-quantization processing according to a second embodiment.

FIG. 17 is a flowchart illustrating details of a process for generating inverse-quantization adjustment value in step S1603 of FIG. 16.

FIG. 18 is a diagram explaining differences in inverse-quantization results due to differences in inverse-quantization correction values.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

### Configuration of Image Processing Apparatus

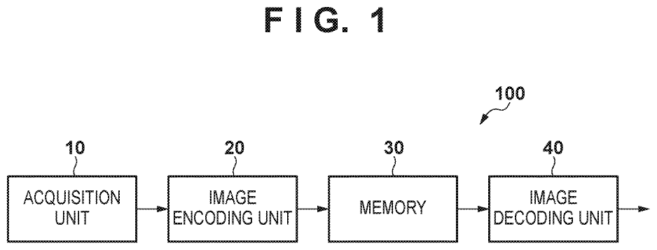

FIG. 1 is a block diagram illustrating a configuration of an image processing apparatus 100 having image encoding and decoding functions according to this embodiment. The image processing apparatus 100 includes an acquisition unit 10, an image encoding unit 20, a memory 30, and an image decoding unit 40.

The functions of each block of the image processing apparatus 100 may be implemented by either software or hardware, except for physical devices such as the storage elements of the memory 30. For example, the functions of each block may be implemented by hardware such as a dedicated device, logic circuit, and memory, or by a memory, a processing program stored in the memory, and a computer such as a CPU that executes the processing program. The image processing apparatus 100 may be implemented as, for example, a digital camera, but may also be implemented as other devices. For example, the image processing apparatus 100 may be implemented as any information processing terminal or electronic device, such as a personal computer, a mobile phone, a smartphone, a PDA, a tablet terminal, a digital video camera, a drone, a robot, or a dashcam.

The acquisition unit 10 has a function of acquiring image data from an image source. The image source may be, for example, an imaging unit equipped with an image sensor, or a communication unit that receives image data from an external device via a transmission path. Alternatively, the acquisition unit 10 may acquire image data via an interface that reads image data from a recording medium or the like. The acquired image data may be still image data or moving image data. When the image data acquired by the acquisition unit 10 is moving image data, multiple frames of the image may be acquired continuously. The acquisition unit 10 supplies the acquired image data to the image encoding unit 20.

The image encoding unit 20 encodes the image data supplied from the acquisition unit 10 according to an encoding method described below, and outputs coded data having a compressed amount of information. The output coded data is stored in the memory 30. The memory 30 functions as a buffer memory and has the storage capacity necessary to store the coded data output from the image encoding unit 20.

The image decoding unit 40 reads out the coded data stored in the memory 30, decodes it into image data using a decoding method described later, and outputs it to a processing unit (not shown) provided downstream.

Although FIG. 1 illustrates the acquisition unit 10, image encoding unit 20, memory 30, and image decoding unit 40 as separate units, some or all of these units may be integrated into a single chip.

### Image Encoding Unit

In this embodiment, the image encoding unit 20 encodes each pixel included in a block of interest, which consists of a predetermined number of pixels, to generate coded data with a code size equal to or less than a predetermined target code size (fixed length). The unit then adds the missing bits (lost bits, described below) to make the coded data have the target code size and outputs the coded data.

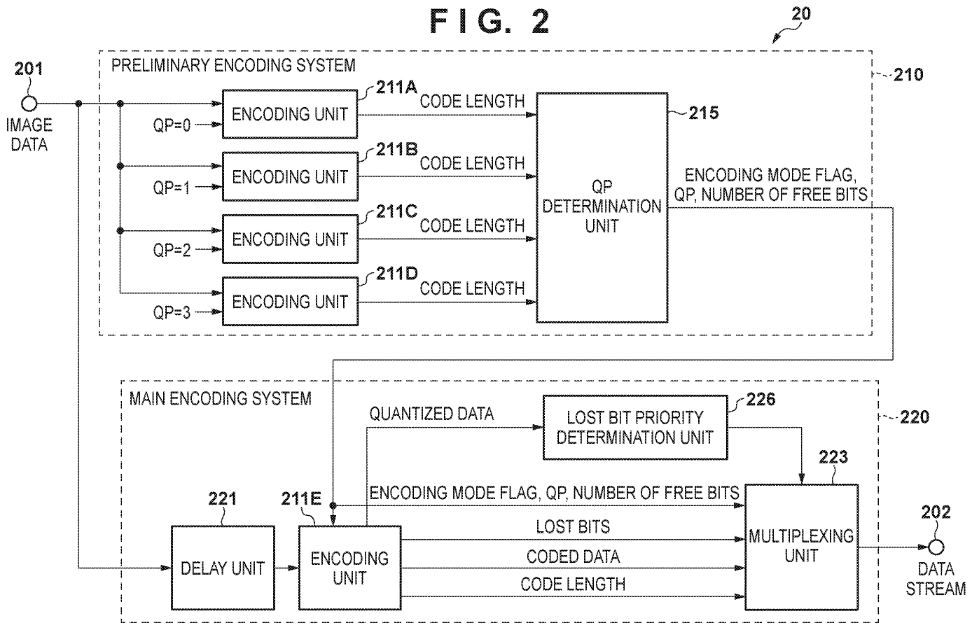

FIG. 2 is a block diagram illustrating the configuration of the image encoding unit 20 in this embodiment. The configuration and operation of the image encoding unit 20 will be described below with reference to FIG. 2.

The image encoding unit 20 includes a preliminary encoding system 210 and a main encoding system 220. The preliminary encoding system 210 includes encoding units 211A-211D and a QP determination unit 215, and operates to determine the encoding mode and quantization parameter (QP) to be used by the main encoding system 220 when performing main encoding. The main encoding system 220 includes a delay unit 221, an encoding unit 211E, a multiplexing unit 223, and a lost bit priority determination unit 226. The main encoding system 220 operates to perform main encoding, including quantization processing, in accordance with the encoding mode and QP determined by the preliminary encoding system 210. Note that since the encoding units 211A to 211E have the same internal configuration, in the following description, the encoding unit 211 may refer to one of the encoding units 211A to 211E.

The image encoding unit 20 may be configured as integrated hardware including a dedicated device, logic circuits, memory, etc., or as a distributed system across multiple hardware components, etc. Alternatively, the image encoding unit 20 may be configured by a memory, a processing program stored in the memory, and a computer such as a CPU that executes the processing program.

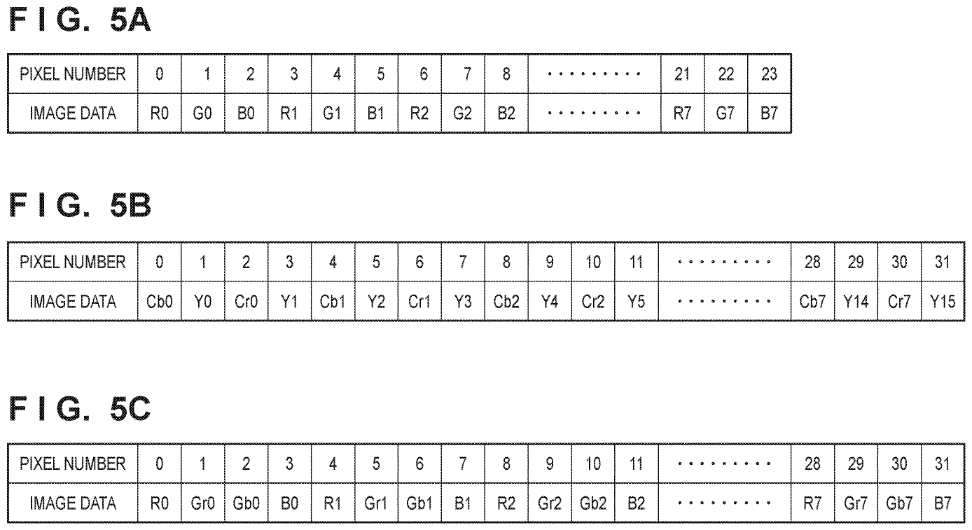

The image encoding unit 20 receives image data to be encoded, acquired by the acquisition unit 10, via an input terminal 201. In the following description, the RGB format shown in FIG. 5A is used as an example of the image data format. It is assumed that the image data is input in raster scan order, and that the pixel data for each color element, R (red), G (green), and B (blue), is time-division multiplexed and input sequentially. It is also assumed that the bit depth of each pixel in this embodiment is 10 bits.

The format and bit depth of the image data are not limited to the RGB format shown in FIG. 5A. For example, the format of the input image data may be the YCbCr 4:2:2 format shown in FIG. 5B or the Bayer array format shown in FIG. 5C. Furthermore, the bit depth of the image data may be 8 bits, 12 bits, for example.

### Encoding Block

In this embodiment, the image encoding processing performed by the image encoding unit 20 divides the image data to be encoded into blocks (encoding blocks) of a predetermined size (number of pixels), and encoding is performed on a block-by-block basis of the encoding block. In the following explanation, as shown in FIG. 5A, an encoding block is assumed to consist of 24 data elements (8 horizontal pixels×1 vertical pixel×3 color components). Also, as shown in FIG. 5A, an encoding block consists of a total of 8 pixels, each with its own R, G, and B color components, arranged in raster scan order as R0, G0, B0, R1, G1, B1, . . . , and so on. While R0, G0, and B0 represent the color components that make up a single pixel, in this embodiment, for convenience, each individual color component will be referred to as a “pixel.” Therefore, in FIG. 5A, each of the 24 data elements is assigned a pixel number from 0 to 23. Encoding is then performed in ascending order of pixel number within the encoding block.

The structure of the encoding block is not limited to that shown in FIG. 5A. For example, in the case of image data in the YCbCr 4:2:2 format shown in FIG. 5B, the encoding block may be composed of 16 Y, 8 Cb, and 8 Cr data elements, for a total of 32 data elements. In the case of FIG. 5B, pixel numbers 0 to 31 are assigned.

Alternatively, in the case of image data in the Bayer array format shown in FIG. 5C, an encoding block may be composed of a total of 32 data elements: 8 Gr, 8 Gb, 8 R, and 8 B. In the case of FIG. 5C, pixel numbers 0 to 31 are assigned. Also, in the case of the Bayer array, the encoding block may have a two-dimensional structure, such as 24 pixels horizontally and 2 pixels vertically.

In this embodiment, the compression ratio for the encoding block shown in FIG. 5A will be described as 6/10. The amount of information of the image data before encoding is 240 bits (24 pixels×10 bits) per encoding block, so the target code size for each encoding block is 144 bits. Note that the target code size of 144 bits is merely an example for ease of understanding and is not limited to this. The image encoding unit 20 selects an encoding mode and QP for each encoding block so that the target code size is not exceeded. The encoding modes include PCM mode, which uses quantized image data as coded data, and DPCM mode, which quantizes image data and then encodes the difference value between the quantized image data and a predicted value.

### Encoding Unit 211

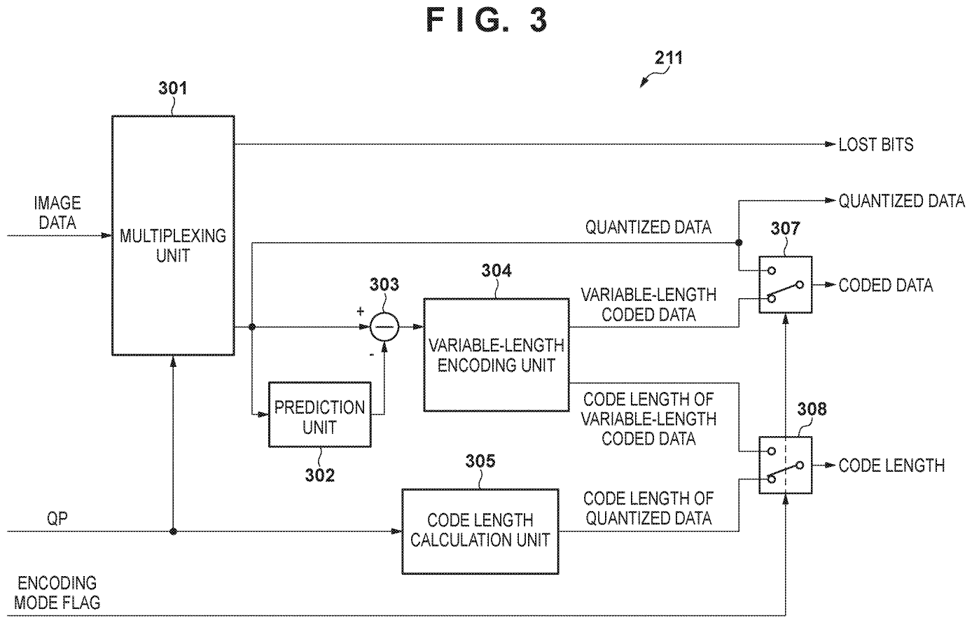

FIG. 3 is a block diagram showing the detailed configuration of the encoding unit 211. As described above, in this embodiment, the encoding units 211A-211E have a common configuration. As shown in FIG. 3, the encoding unit 211 includes a quantization unit 301, a prediction unit 302, a subtractor 303, a variable-length encoding unit 304, a code length calculation unit 305, a selector 307, and a selector 308.

The encoding unit 211 receives image data and a quantization parameter QP for each encoding block, as well as an encoding mode flag (not shown in the preliminary encoding system 210 of FIG. 2). In the preliminary encoding system 210, a fixed QP is assigned to each of the encoding units 211A-211D in advance. In this embodiment, as shown in FIG. 2, QPs of 0, 1, 2, and 3 are assigned to the encoding units 211A-211D, respectively. Note that in the preliminary encoding system 210, each of the encoding units 211A-211D may hold a QP value in advance. In addition, in the preliminary encoding system 210, a fixed value indicating DPCM mode is input as the encoding mode flag. The encoding mode flag and QP determined by the QP determination unit 215 of the preliminary encoding system 210 are supplied to the encoding unit 211E of the main encoding system 220.

The specific configuration and operation of the encoding unit 211 are described in detail below.

First, the image data of the encoding block input to the encoding unit 211 (here, described as 24 pixel data shown in FIG. 5A) is input to the quantization unit 301. The quantization unit 301 quantizes each pixel data of the input image data according to a given QP, generating quantized data and bit data lost by quantization (lost bits). The quantization unit 301 then outputs the generated quantized data to the prediction unit 302, subtractor 303, selector 307, and outside the encoding unit 211. The quantization unit 301 also outputs the generated lost bits outside the encoding unit 211.

In this embodiment, the QP value is an integer value with 0 as the minimum value and can be changed in the range from 0 to 3, but a larger QP value may be set and quantization may be performed using an even larger quantization step.

In this embodiment, the quantization unit 301 reduces (makes finer) the quantization step as the QP decreases, and increases (makes coarser) the quantization step as the QP increases. Specifically, the quantized data is generated by the operation expressed by Equation (1), and the lost bits are generated by the operation expressed by Equation (2).

Quant=Data>>QP (1)

Loss=Data−(Quant<<QP) (2)

Here, Quant indicates quantized data, Loss indicates lost bits, Data indicates each pixel data of the input image data, and QP indicates a quantization parameter. Also, >> indicates a right shift operation, and << indicates a left shift operation. In other words, the quantized data Quant is the quotient when the pixel data value is divided by 2QP, and indicates that the number of effective bits is reduced from 10 bits to 10-QP bits. Also, the lost bits Loss indicates the remainder truncated in the division, and indicates that the number of bits is QP.

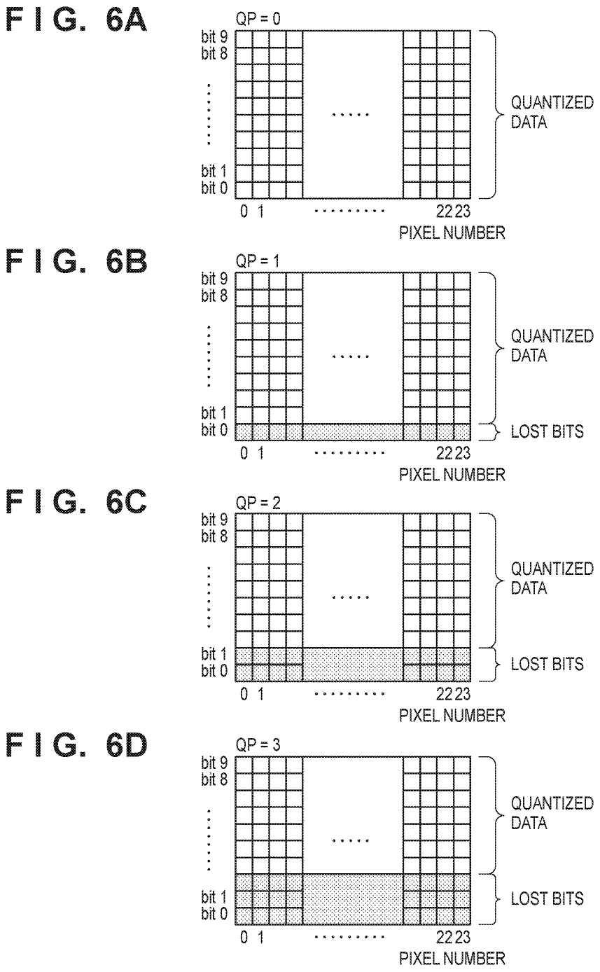

Here, quantized data and lost bits will be explained with reference to FIGS. 6A to 6D. FIGS. 6A to 6D are diagrams showing the concept of all bits that make up the image data contained in each encoding block, and represent an arrangement of 24 pixel data in the horizontal direction and a bit depth of 10 bits (bit 0 to bit 9) in the vertical direction.

FIG. 6A shows the quantized data when QP=0 (output of the quantization unit 301 of the encoding unit 211A), indicating that the input image data is output as is without being quantized. In this case, there are no lost bits.

FIG. 6B shows the quantized data and lost bits when QP=1 (output of the quantization unit 301 of the encoding unit 211B), indicating that the upper 9 bits are output as quantized data and the least significant bit is output as lost bits.

FIG. 6C shows the quantized data and lost bits when QP=2 (output of the quantization unit 301 of the encoding unit 211C), indicating that the upper 8 bits are output as quantized data and the lower 2 bits are output as lost bits.

FIG. 6D shows the quantized data and lost bits when QP=3 (output of the quantization unit 301 of the encoding unit 211D), indicating that the upper 7 bits are output as quantized data and the lower 3 bits are output as lost bits.

In this embodiment, for example, increasing QP by one from “A” to “A+1” (in this embodiment, A is 0, 1, or 2) is expressed as raising the quantization step by one step, increasing it by one step, or making it coarser by one step, etc. Conversely, decreasing QP by one from “B” to “B−1” (in this embodiment, B is 1, 2, or 3) is expressed as lowering the quantization step by one step, decreasing it by one step, or making it finer by one step, etc.

The code length calculation unit 305 determines the code length of the quantized data per pixel output from the quantization unit 301 using Equation (3) based on the bit depth of the image data (10 bits in this embodiment) and QP.

Code length of quantized data=bit depth of image data−QP (3)

In this embodiment, the code length of the quantized data decreases by one bit each time QP increases by one. Therefore, starting from QP=0 as the initial value, the code length of 10 bits of the quantized data decreases by one bit each time QP increases by one. In the preliminary encoding system 210, a fixed QP value is assigned to each of the encoding units 211A-211D, so the code length of quantized data is also a fixed value. Therefore, the code length calculation unit 305 may be configured to hold and output a fixed value of the code length of quantized data based on the assigned QP value, rather than calculating the code length of the quantized data using Equation (3). The code length calculation unit 305 outputs the determined code length of quantized data to the selector 308.

Next, the operation of the prediction unit 302 will be described. The prediction unit 302 generates predicted data for the current quantized data (predicted quantized value of the current pixel) using surrounding quantized data. A simple method is to use previous pixel data of the same color as the predicted data. For example, in this embodiment, as shown in FIG. 5A, in a case where image data for each RGB color element is input in order, after encoding image data G0, image data B0 and R1 are encoded before encoding G1. Therefore, the prediction unit 302 delays the quantized data by three pixels and outputs it as predicted data. The prediction unit 302 may also perform calculations such as linear prediction using a plurality of previous pixel data of the same color. Alternatively, if the encoding block has a two-dimensional structure, calculations such as planar prediction using surrounding pixel data of the same color or MED prediction, which is used in JPEG-LS, may be performed. Note that there is no previous pixel data for the pixel data of the first three pixels of the encoding block (R0, G0, B0). Therefore, the prediction unit 302 outputs a predetermined value (for example, 0) to the subtractor 303 as predicted data for the pixel data of the first three pixels of the encoding block.

The subtractor 303 outputs the difference between the quantized data from the quantization unit 301 and the predicted data from the prediction unit 302 as prediction difference data to the variable-length encoding unit 304. The prediction difference data has positive and negative values, and takes values close to 0 in flat areas where the image data fluctuates little, and takes large values in edge areas where the image data fluctuates greatly. The prediction difference data generally has the characteristics of a Laplace distribution centered on 0.

The variable-length encoding unit 304 encodes the input prediction difference data using a predetermined variable-length encoding method, and outputs the generated variable-length coded data to the selector 307 and the code length of the variable-length coded data to the selector 308. For example, Huffman coding, Golomb coding, etc. can be used as the variable-length encoding method. In the variable-length encoding method executed by the variable-length encoding unit 304, coded data with the shortest code length is assigned when the input value is 0, and the larger the absolute value of the input value is, the longer the code length of the coded data becomes.

The selector 307 receives the quantized data and the variable-length coded data, selects one of them according to the encoding mode flag, and outputs the selected data as coded data to the outside of the encoding unit 211. In this embodiment, the selector 307 selects the variable-length coded data when the encoding mode flag has a value of 0, and selects the quantized data when the encoding mode flag has a value of 1.

The selector 308 receives the code length of the quantized data and the code length of the variable-length coded data, selects one of them according to the encoding mode flag, and outputs the selected code length to the outside of the encoding unit 211. In this embodiment, the selector 308 selects the code length of the variable-length coded data when the value of the encoding mode flag is 0, and selects the code length of the quantized data when the value of the encoding mode flag is 1.

Here, the encoding mode will be described. The encoding unit 211 operates by switching between the DPCM mode and the PCM mode according to the encoding mode flag that indicates the encoding mode. In the DPCM mode, the subtractor 303 generates prediction difference data using quantized data quantized by the quantization unit 301 and predicted data generated by the prediction unit 302, and the variable-length encoding is performed by the variable-length encoding unit 304. In the DPCM mode, variable-length coded data is generated based on the image data and QP. In the DPCM mode, the encoding mode flag is set to “0.” On the other hand, in the PCM mode, input image data is quantized directly by the quantization unit 301 and output as quantized data. In the PCM mode, coded data of a fixed length determined by the QP is generated. In the PCM mode, the encoding mode flag is set to “1.”

In the PCM mode, when multiplexing coded data (described later), it is necessary to multiplex a one-bit flag indicating that the coded data was generated in the PCM mode. Therefore, a predetermined pixel among the pixels in the encoding block is quantized by increasing the QP by one step, and coded data that is one bit less than those of the other pixels and a code length are output. The predetermined pixel may be, for example, the pixel located at the left end (first) of the encoding block.

### Explanation of the Preliminary Encoding System

Referring back to FIG. 2, the processing performed by the preliminary encoding system 210 will be explained below.

Image data input to the preliminary encoding system 210 in FIG. 2 is provisionally encoded by the plurality of encoding units 211A-211D in DPCM encoding mode using QP values of 0-3, respectively. The encoding units 211A-211D then output the encoding results to the QP determination unit 215. Note that while the signals output by the encoding units 211A-211D include coded data, code length, quantized data, and lost bits, as shown in FIG. 3, the QP determination unit 215 uses only the code length. Note that in the preliminary encoding system 210, the encoding mode flag is a fixed value (0) indicating the DPCM mode, so the QP determination unit 215 effectively uses the code length of the variable-length coded data.

In this embodiment, the QP range used for encoding is set to 0 to 3, so the preliminary encoding system 210 includes four encoding units 211A-211D. However, this is for the purpose of concreteness and simplification of the explanation, and the number of the encoding units 211 can be changed depending on the range of QP used for encoding.

Although not shown, a target code size and the number of pixels in the encoding block are provided to the QP determination unit 215. Note that the target code size may be input as the target code size itself, or the image data amount of the encoding block and the compression rate may be input to allow the QP determination unit 215 to calculate the target code size.

The QP determination unit 215 determines the encoding mode and QP (hereinafter referred to as the “encoding mode to be employed” and “QP to be employed”) for the encoding block to be processed in the main encoding system 220 based on the code length information of one encoding block for each QP input from the encoding units 211A-211D. The QP determination unit 215 also performs free space determination processing for calculating the number of free bits (free_num[qp], described below) from the target code size and the code length of the block. The free space determination processing will be described later. In this embodiment, the QP determination unit 215 is assumed to have a built-in buffer that temporarily stores the data input from each of the encoding units 211A-211D. The method for determining the encoding mode to be employed and QP to be employed in the QP determination unit 215 will be described in detail below.

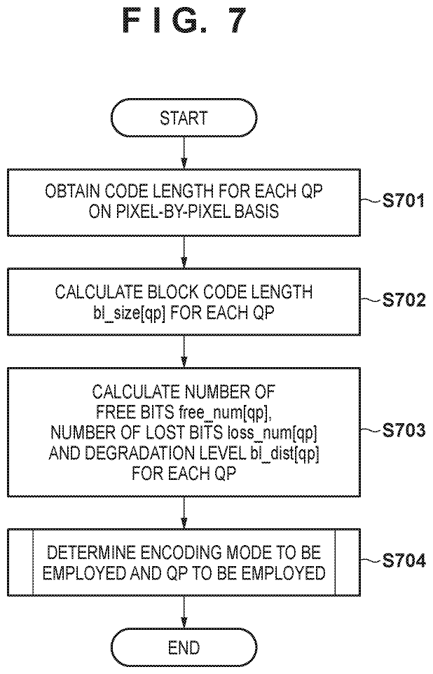

FIG. 7 is a flowchart explaining in detail the processing for determining the encoding mode to be employed and the QP to be employed in the QP determination unit 215.

First, in step S701, the QP determination unit 215 obtains, on a pixel-by-pixel basis, information on the code length calculated for each QP assigned to each encoding unit from the encoding units 211A-211D.

In step S702, the QP determination unit 215 sums the acquired pixel-by-pixel code lengths and calculates the code length of the entire encoding block for each QP (hereinafter referred to as the “block code length”). In this embodiment, the preliminary encoding system 210 has four encoding units 211A-211D, so the QP determination unit 215 calculates four block code lengths. When calculating the block code length, it is necessary to take into account the code length of the header information multiplexed onto the coded data. The header information is information for each encoding block that is required for decoding. In this embodiment, the code length of the header information is three bits, consisting of two bits for expressing the QP (0 to 3) and one bit for the encoding mode flag. Therefore, in step S702, the QP determination unit 215 calculates the block code length bl_size[qp] by adding the code length hd_size (=3 bits) of the header information to the sum of the pixel-by-pixel code lengths. Here, [qp] is a value corresponding to QP. Note that the number of bits for expressing QP can be changed depending on the range of QP used for encoding.

At step S703, the QP determination unit 215 calculates the number of free bits free_num[qp] and the number of lost bits loss_num[qp] for each QP using the target code size target_size (144 bits in this embodiment) and the block code length bl_size[qp] for each QP. The QP determination unit 215 also calculates the degradation level bl_dist[qp] for each QP using the number of free bits free_num[qp] and the number of lost bits loss_num[qp]. The number of free bits free_num[qp] is calculated using Equation (4).

free_num[qp]=target_size−bl_size[qp] (4)

The number of free bits is the value obtained by subtracting the block code length from the target code size, as shown in the equation (4). A positive value for the number of free bits indicates that the block code length with the corresponding QP is smaller than the target code size. A negative value for the number of free bits indicates that the block code length with the corresponding QP is larger than the target code size.

The number of lost bits loss_num[qp] is calculated using Equation (5).

loss_num[qp]=QP×pix_num (5)

Here, pix_num is the number of pixels in the encoding block (“24” in this embodiment).

The number of lost bits loss_num[qp], indicates the number of bits lost due to quantization and is a value uniquely determined by QP and the number of pixels in the encoding block. Here, since the number of pixels pix_num in the encoding block in this embodiment is 24, for example, the number of lost bits, loss_num[2], when QP=2, is 48.

The degradation level bl_dist[qp] is calculated using Equation (6).

bl_dist[qp]=loss_num[qp]−free_num[qp] (6)

The degradation level bl_dist[qp] indicates the degree of degradation in encoding. In this embodiment, when the block code length is smaller than the target code size, encoding is performed so that the bit data (lost bits) lost due to quantization is stored in the free bits area as much as possible. During decoding, the lost bits stored in the free bits area are restored to reduce the degradation due to quantization. Therefore, the final degree of degradation is the value obtained by subtracting the number of free bits from the number of lost bits.

In step S704, the QP determination unit 215 determines the encoding mode to be employed and QP to be employed using the bl_size[qp] calculated in step S702 and the bl_dist[qp] calculated in step S703.

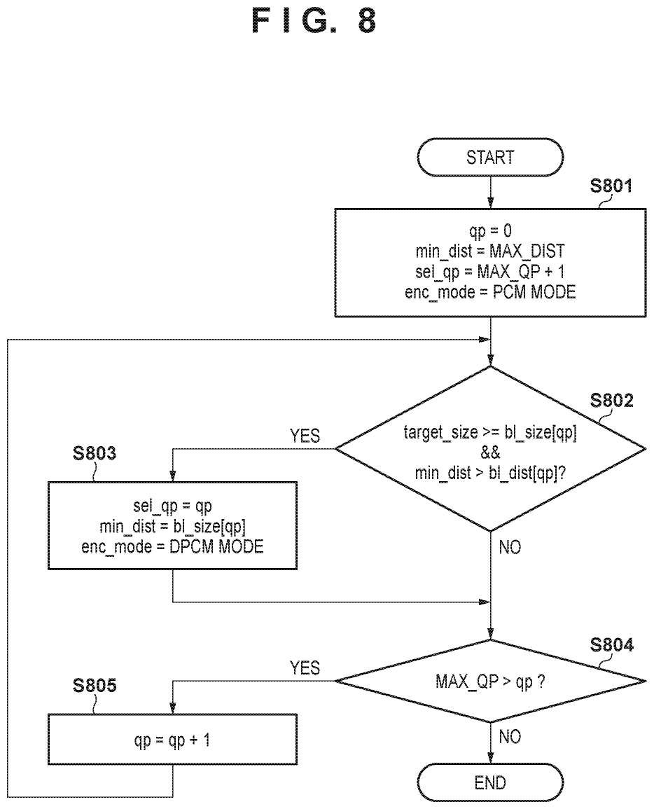

The process of step S704 will now be described in detail with reference to FIG. 8.

In step S801, the QP determination unit 215 initializes variables. Specifically, the QP determination unit 215 initializes qp (QP value) to 0 and min_dist (value of minimum degradation level) to a preset MAX_DIST. The QP determination unit 215 also initializes sel_qp (QP to be employed) to the value MAX_QP+1. Here, MAX_DIST is the maximum possible value for the degradation level of the encoding block, and is the value obtained by subtracting the target code size from the image data amount of the encoding block before encoding. In this embodiment, MAX_DIST=240−144 =96. MAX_QP is the maximum QP value used for encoding in the encoding units 211A-211D. In this embodiment, MAX_QP is 3, so sel_qp is initialized to 4. The initial value of sel_qp is initialized as the QP to be employed in a case where the conditions for selecting the QP to be employed, which will be described below, are not met for any QP. In addition, the PCM mode is set as the initial value for the encoding mode to be employed enc_mode.

In step S802, the QP determination unit 215 determines whether the following conditions are met for the current QP (variable qp): the block code length bl_size[qp] calculated in step S702 is equal to or less than the target code size target_size, and the degradation level bl_dist[qp] of the encoding block calculated in step S703 is less than min_dist. If these conditions are met, the QP determination unit 215 advances the process to step S803; if not, the QP determination unit 215 advances the process to step S804.

In step S803, the QP determination unit 215 updates sel_qp to the current qp as a candidate QP to be selected. The QP determination unit 215 also updates min_dist to the current degradation level bl_dist[qp]. Since it is determined that the DPCM mode is to be used as the encoding mode at this point, the QP determination unit 215 changes enc_mode to the DPCM mode.

In step S804, the QP determination unit 215 determines whether the value of the current QP (variable qp) is smaller than the maximum value MAX_QP. If qp<MAX_QP holds, the process proceeds to step S805; if not, the processing of this flowchart ends.

In step S805, the QP determination unit 215 adds 1 to qp. After that, the same processes are performed again from step S802 for the next QP value.

If step S802 never returns “YES” and step S804 returns “NO,” this means that in the DPCM mode, no QP exists with a block code length smaller than the target code size, and the block code length cannot fit within the target code size. In this case, enc_mode and sel_qp remain at the PCM mode and 4 (=MAX_QP+1) initialized in step S801, respectively, and the processing in FIG. 8 ends.

As a result of the above processing, if any of the block code length bl_size[qp] calculated in step S702 is equal to or smaller than the target code size, the DPCM mode is selected as the encoding mode to be employed, and the QP that minimizes the degradation level bl_dist[qp] of the encoding block calculated in step S703 is selected as the QP to be employed. On the other hand, if all of the block code lengths bl_size[qp] exceed the target code size, the PCM mode is selected as the encoding mode to be employed, and the qp value “4”, which is the maximum QP value (MAX_QP) plus 1, is used as the QP to be employed.

Then, the QP determination unit 215 outputs the encoding mode flag of the encoding mode to be employed obtained by the above-mentioned processing, the QP to be employed, and the number of free bits in the QP to be employed.

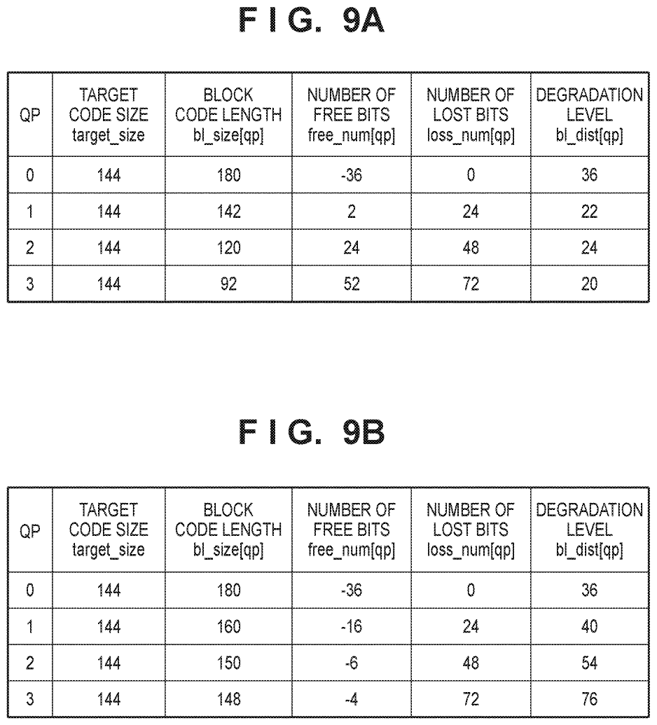

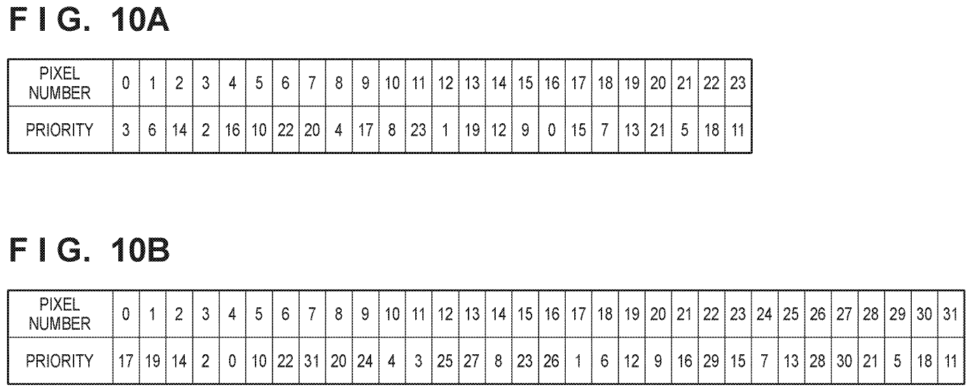

FIGS. 9A and 9B show specific examples of block code length bl_size[qp] and degradation level bl_dist[qp]. In the example of FIG. 9A, when QP=3, the block code length bl_size[3]=92 bits is less than or equal to the target code size of 144 bits, and the degradation level bl_dist[3]=20 is the minimum. Therefore, in the case of FIG. 9A, QP=3 is selected as the QP to be employed and the DPCM mode is selected as the encoding mode to be employed by the processing shown in FIG. 8. In the example of FIG. 9B, the block code lengths exceed the target code size for all QPs. Therefore, in the case of FIG. 9B, QP=4 is selected as the QP to be employed and the PCM mode is selected as the encoding mode to be employed by the processing shown in FIG. 8.

As explained with reference to Equation (6), the degradation level bl_dist[qp] is the value obtained by subtracting the number of free bits free_num[qp] from the number of lost bits loss_num[qp]. Here, when the right side of Equation (4) is substituted for the number of free bits free_num[qp] in Equation (6), the following Equation (7) is obtained.

bl_dist[qp]=loss_num[qp]−(target_size−bl_size[qp])=loss_num[qp]+bl_size[qp]−target_size (7)

In Equation (7), the target code size target_size is constant regardless of the QP value, and the block code length corresponding to the header information in the block code length bl_size[qp] is also constant regardless of the QP value. Therefore, the magnitude relationship between the degradation levels between QPs is determined by the sum of the code lengths (block code length) and the number of lost bits loss_num[qp] output by the encoding unit 211. Therefore, the QP determination unit 215 can determine the QP to be employed and the encoding mode to be employed based on the block code length and the number of lost bits without calculating the degradation level. In the example of FIG. 9A, among QPs whose block code length is smaller than the target code size, the sum of the block code length and the number of lost bits is smallest when QP=3, so the DPCM mode is determined as the encoding mode to be employed and QP=3 is determined as the QP to be employed. In the example of FIG. 9B, since all of the block code lengths corresponding to respective QPs exceed the target code size, the PCM mode is determined as the encoding mode to be employed and QP=4 is determined as the QP to be employed so that the code size of the encoding block is equal to or less than the target code size.

### Encoding Process in the Main Encoding System 220

The main encoding system 220 receives the same image data as the image data of the encoding block input to the preliminary encoding system 210. However, the encoding process in the main encoding system 220 cannot begin until the QP determination unit 215 of the preliminary encoding system 210 determines and outputs the encoding mode to be employed and the QP to be employed. Therefore, the input image data of the encoding block is first input to the delay unit 221 and delayed by the number of processing cycles required for the preliminary encoding system 210 to determine the encoding mode to be employed and the QP to be employed. The delayed image data of the encoding block is then output from the delay unit 221 and input to the encoding unit 211E. This allows the encoding unit 211E to perform encoding using the encoding mode to be employed and the QP to be employed determined by the preliminary encoding system 210.

The encoding unit 211E receives the delayed image data of the encoding block, the encoding mode flag for the encoding mode to be employed, and the QP to be employed out of the data output from the QP determination unit 215. The encoding unit 211E then performs the main encoding process on the delayed image data in accordance with the input encoding mode flag and the QP to be employed. This generates coded data with the same code length as the block code length determined by the QP determination unit 215. The encoding unit 211E outputs the generated coded data, along with the code length and lost bits, to the multiplexing unit 223. The encoding unit 211E also outputs the quantized data quantized in accordance with the QP to be employed to the lost bit priority determination unit 226.

The lost bit priority determination unit 226 determines a priority for determining the number of lost bits to be stored for each pixel in the multiplexing unit 223, which will be described later, and outputs the priority to the multiplexing unit 223. This priority is a unique value determined for each pixel in the encoding block. For example, if the encoding block has 24 pixels, there are 24 values corresponding to pixel numbers 0 to 23, and this set is called a priority pattern. Here, how lost bits are stored and how the priority works in this case will be explained.

The lost bits are stored in order from the MSB side of the lost bits of each pixel as long as they can be stored in the free bits of the number of free bits free_num[sel_qp] (sel_qp is QP to be employed).

When storing the lost bits of each pixel starting from the MSB, in many cases the number of lost bits that can be stored varies from pixel to pixel. For example, if an encoding block has 24 pixels and the number of free bits is 38, 14 of the 24 pixels can store 2 of the lost bits, and the remaining 10 pixels can store 1 of the lost bits. Therefore, priority is used to determine which pixel of one more lost bit will be stored. The higher the priority, the more lost bits will be stored.

For example, if the priority is assigned to each pixel of an encoding block from left to right, pixels for which one more bit can be stored tend to be located consecutively on the left side of the block, resulting in an average quantization error that is smaller on the left side and larger on the right side of the encoding block. When viewing an image obtained by decoding such encoding blocks across the entire screen, the quantization error becomes easily noticeable. Similarly, if the high-priority pixels or the low-priority pixels are set consecutively, such as the order from right to left or from the left and right edges to the center, areas with small quantization error and with large quantization error will be distributed in the same manner in the encoding blocks, resulting in a similar problem.

Therefore, in this embodiment, random priorities are generated for pixel numbers so that pixels for which one more lost bit can be stored and pixels whose one lost bit cannot be stored are not consecutive within an encoding block.

FIGS. 10A and 10B are tables showing an example of a priority pattern for storing lost bits with respect to pixel numbers in a given encoding block. FIG. 10A shows a priority pattern when the encoding block has 24 pixels, and FIG. 10B shows an example of a priority pattern when the encoding block has 32 pixels. In FIG. 10A, values from 0 to 23 are assigned to each pixel number in random order as a priority, and can be determined arbitrarily. The lower the priority assigned to a pixel number, the higher the priority for allocating lost bits. In the figure, the order of the pixel numbers according to the ascending order of priority is 16, 12, 3, etc., ending with 11.

The specific configuration of the lost bit priority determination unit 226 may be configured with a ROM or RAM device, with the priority patterns stored in advance as a table, or may be configured with a pseudorandom value generation circuit, with the priority patterns generated.

Furthermore, while the above example of priority patterns shows an example in which the same priority pattern is output for each encoding block, the priority pattern may be changed according to the pixel values of the input image data so that the priority pattern changes for each encoding block. In this way, the pixel positions where quantization errors occur change in different encoding blocks, making the encoding errors less noticable.

The priority pattern can be changed for each encoding block by using coordinate position information of the encoding block or by using quantized data from the encoding unit 211E.

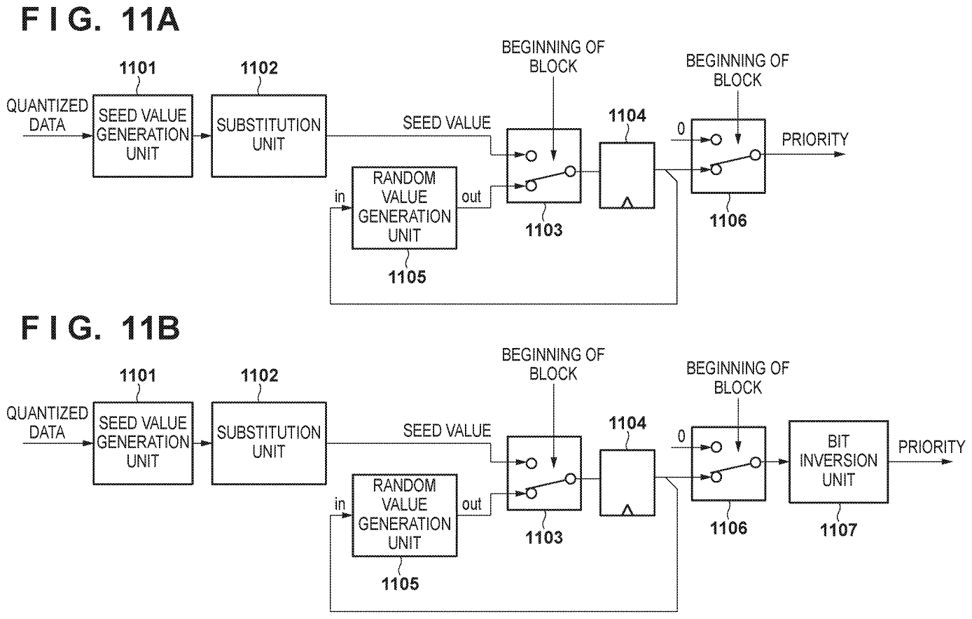

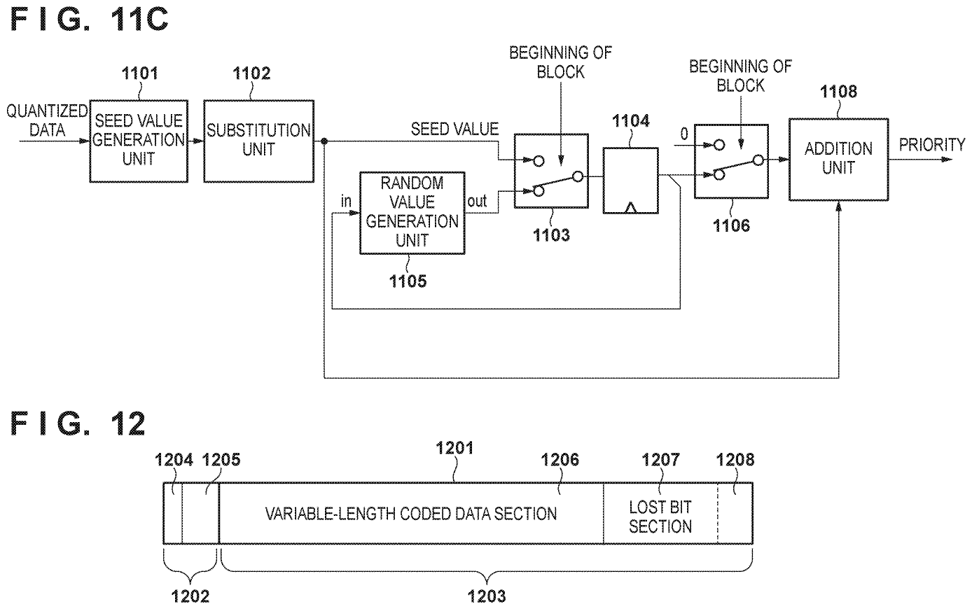

FIG. 11A shows an example of the configuration of a pseudorandom value generation circuit used in the lost bit priority determination unit 226. In FIG. 11A, the pseudorandom value generation circuit is configured to output a different priority pattern for each encoding block by using quantized data as a seed value for the pseudorandom value generation circuit. In the figure, the pseudorandom value generation circuit is composed of a seed value generation unit 1101, a substitution unit 1102, a selector 1103, a register 1104, a random value generation unit 1105, and a selector 1106.

Next, the operation of the pseudorandom value generation circuit will be described. Here, a method for generating random values between 0 and 31 when the number of pixels in an encoding block is 32 will be explained. First, using the quantized data input from the encoding unit 211E, the seed value generation unit 1101 generates a seed value for generating random values. The number of bits of the seed value must be the same as the number of bits of the random value to be generated, so in this example, it is 5 bits. If the number of bits of the input quantized data is greater than this, it is adjusted to the required number of bits using a logical operation such as exclusive OR (XOR). For example, if the quantized data is 10 bits, the upper 5 bits and the lower 5 bits can be XORed to make it 5 bits. Even if the quantized data has other bit numbers, a seed value with the same number of bits as the random value can be generated using any combination

The generated seed value is input to the substitution unit 1102, which replaces the seed value with a predetermined value other than 0 if the seed value is 0. This is because, in the random value generation unit 1105 described below, if the seed value is 0, no random value is generated (it remains 0). The seed value output from the substitution unit 1102 is input to the register 1104 via the selector 1103. The selector 1103 operates to select the seed value from the seed value generation unit 1101 in the cycle of the beginning of the encoding block. The register 1104 is a multi-bit register that holds the seed value and random values, and holds data input in response to a clock signal (not shown). The value held in the register 1104 is input to the random value generation unit 1105.

The random value generation unit 1105 uses the principle of random generation using a general linear feedback shift register, and generates multiple bits simultaneously. As an example, the logical expressions for generating 5-bit output data out[4:0] from 5-bit input data in[4:0] are shown in Equations (8) to (12). The symbol \hat{ } in the equations represents an XOR operation.

out[0]=in[4]\hat{ }in[1] (8)

out[1]=in[3]\hat{ }in [0] (9)

out[2]=in[2]\hat{ }in [4]\hat{ }in[1] (10)

out[3]=in[1]\hat{ }in[3]\hat{ }in[0] (11)

out[4]=in[0]\hat{ }in[2]\hat{ }in[4]\hat{ }in[1] (12)

The output of the random value generation unit 1105 is connected to the register 1104 via the selector 1103. This causes the register 1104 to hold the seed value from the seed value generation unit 1101 in the first cycle of the encoding block, and to hold the output of the random value generation unit 1105 in other cycles. The value held in the register 1104 is input to the random value generation unit 1105, which operates to generate random values sequentially, so that values 1 to 31 are generated in random order for each cycle at which the clock is input.

The output from the register 1104 is a seed value in the first cycle of the encoding block, and a random value between 1 and 31 is output in the following 31 cycles. In other words, since 0 does not appear, the seed value output at the beginning of the encoding block is replaced with 0 using the selector 1106.

In this case, the value at the beginning of the encoding block will always be 0, and the highest priority will be fixed to the first pixel of the block. Therefore, as shown in FIG. 11B, a bit inversion unit 1107 may be provided after the selector 1106 to invert some or all of the bits of the random value. This shifts the value with the priority 0 to another pixel position, preventing the first pixel of the encoding block from always having the priority 0.

Alternatively, as shown in FIG. 11C, an addition unit 1108 may be provided after the selector 1106 to add a seed value to the priority data (the carry bit is discarded). This improves the randomness of the priority of the first pixel of the encoding block.

### Description of the Multiplexing Unit 223 in the Main Encoding System 220

Referring again to FIG. 2, the multiplexing unit 223 in the main encoding system 220 will be explained.

The multiplexing unit 223 receives the coded data, code length, and lost bits from the encoding unit 211E, as well as the encoding mode flag, the QP to be employed, and the number of free bits output from the QP determination unit 215. Furthermore, the multiplexing unit 223 receives a priority pattern from the lost bit priority determination unit 226. The multiplexing unit 223 then multiplexes the input data in a predetermined format for each encoding block.

The encoding format for the DPCM mode will now be described with reference to FIG. 12. As mentioned above, if the number of pixels in an encoding block is 24, the bit depth of the pixel data is 10 bits, and the compression rate is 6/10, the size of a coded block 1201 shown in FIG. 12 is equal to the target code size of 144 bits.

The coded block 1201 includes a header section 1202 (3 bits) and a pixel data section 1203 (141 bits). The header section 1202 includes an encoding mode flag 1204 (1 bit) that indicates the encoding mode, and a QP value section 1205 (2 bits) that indicates the QP. The pixel data section 1203 includes a variable-length coded data section 1206, a lost bit section 1207, and a stuffing section 1208. Note that the stuffing section 1208 may not be present.

The encoding mode flag and the QP output from the QP determination unit 215 are stored in the encoding mode flag 1204 (1 bit) and the QP value section 1205 (2 bits) of the header section 1202, respectively. In this embodiment, the value of the encoding mode flag indicating the DPCM mode is 0. The variable-length coded data (24 pixels) from the encoding unit 211E is packed bit by bit using the code length for each pixel and stored in the variable-length coded data section 1206.

The lost bits output from the encoding unit 211E are stored in order based on a priority pattern in the lost bit section 1207 of the coded block 1201. The lost bit section 1207 is the area that immediately follows the variable-length coded data section 1206. The method of storing the lost bits will be described in detail later.

If the amount of variable-length coded data in the variable-length coded data section 1206 is the same size as the pixel data section 1203, no area remains to store lost bits in the coded block 1201. In this case, lost bits are not stored in the coded block 1201. Also, if the total size of the header section 1202, variable-length coded data section 1206, and lost bit section 1207 is less than the target code size, the stuffing section 1208 (dummy bits) fills the remaining area.

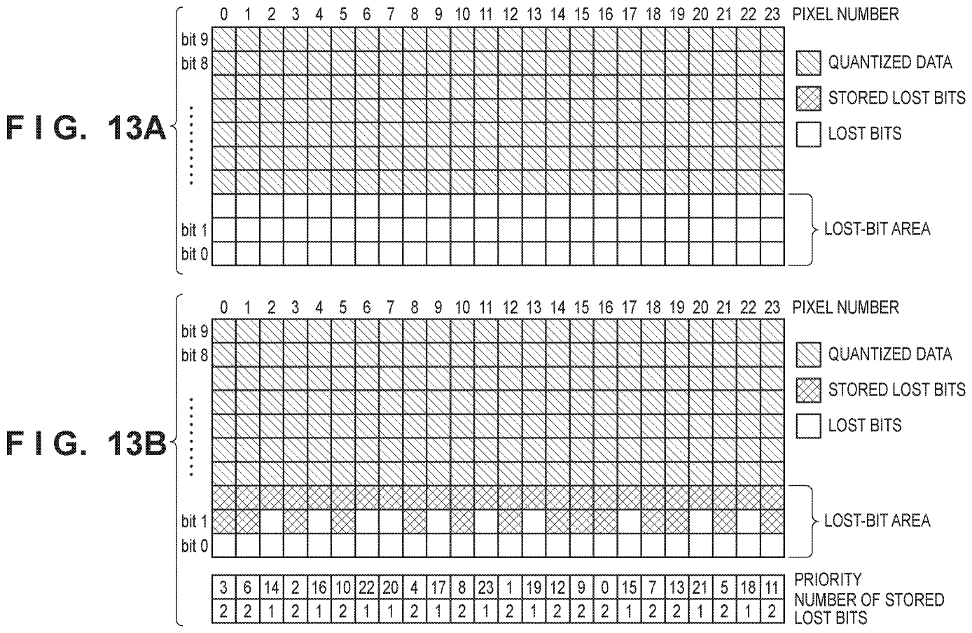

Here, a method for storing lost bits in the DPCM mode will be described with reference to FIGS. 13A and 13B. For ease of understanding, FIGS. 13A and 13B show all bits of image data in an encoding block when QP=3 is selected, representing an arrangement of 24 pixel data in the horizontal direction and a bit depth of 10 bits in the vertical direction.

FIG. 13A shows all bits of the encoding block before the multiplexing unit 223 stores the lost bits, with the most significant 7 bits of each pixel being quantized data and the least significant 3 bits being lost bits. The multiplexing unit 223 determines the number of lost bits to store for each pixel according to the priority of multiplexing the lost bits, and stores the lost bits in a lost-bit area shown in FIG. 13A in the lost bit section 1207 shown in FIG. 12.

Here, a method of determining the number of lost bits to be stored for each pixel will be explained with reference to FIG. 15.

FIG. 15 is a flowchart showing the method of determining the number of lost bits to be stored for each pixel. In the figure, free_num[sel_qp] is the number of free bits in the QP to be employed, pix_num is the number of pixels in the encoding block, less_bits is the number of lost bits that can be stored in each pixel, more_bits is the number of lost bits that can be stored per pixel which can store one more bit, more_pix_num is the number of pixels that can store one more lost bit, pix is an internal variable for loop processing, priority[pix] is the priority for storing lost bits for each pixel, and store_bits[pix] is the number of lost bits to be stored in each pixel. The arithmetic symbol “/” indicates division (decimals are discarded), and “%” indicates the remainder.

In step S1500, the number of lost bits that can be stored per pixel, less_bits, is calculated. This is the quotient (integer) obtained by dividing the number of free bits, free_num[sel_qp], by the number of pixels in the encoding block, pix_num. Next, the number of lost bits, more_bits, which is the number of lost bits that can be stored for each pixel capable of storing one more bit, is calculated. This is calculated by adding 1 to less_bits. Next, the number of pixels for which one more lost bit can be stored, more_pix_num, is calculated. This is the remainder when the number of free bits, free_num[sel_qp], is divided by the number of pixels in the encoding block, pix_num.

In step S1501, an internal variable pix for looping through steps S1502 to S1505 for the number of pixels is reset to 0.

In step S1502, the priority priority[pix] for storing lost bits for each pixel determined by the lost bit priority determination unit 226 is compared with the number of pixels more_pix_num for which one more lost bit can be stored. If priority[pix] is smaller than more_pix_num, the process proceeds to step S1503, where the number of lost bits for pixels for which one more bit more_bits can be stored is substituted for the number of lost bits to be stored in the pixel, store_bits[pix]. If priority[pix] is equal to or greater than the number of pixels, more_pix_num, for which one more lost bit can be stored, the process proceeds to step S1504, where the number of lost bits to be stored in the pixel store_bits[pix] is replaced by the number of lost bits of each pixel that can stored, less_bits.

In step S1505, the internal variable pix is compared with the number of pixels pix_num in the encoding block, and if the internal variable pix is smaller, in step S1506, 1 is added to the internal variable pix to determine the number of lost bits to be stored of the next pixel, the process proceeds to step S1502, and the above-mentioned processes are repeated. Then, when the internal variable pix becomes equal to or greater than the number of pixels pix_num in the encoding block, it is determined that the determination of the number of lost bits to be stored has been completed for every pixel, and the processing ends.

In this way, the number of lost bits to be stored for each pixel, store_bits [pix], is determined.

FIG. 13B is a diagram illustrating all bits of the encoding block after the multiplexing unit 223 has stored the lost bits, and additionally shows the priority of pixels for storing the lost bits and the number of lost bits to be stored in each pixel.

FIG. 13B shows an example where the number of free bits free_num[sel_qp] is 38, and in this case, the number of pixels for which one more lost bit can be stored, more_pix_num, is 14. This shows that pixels with a priority priority[pix] of less than 14 can store one more lost bit.

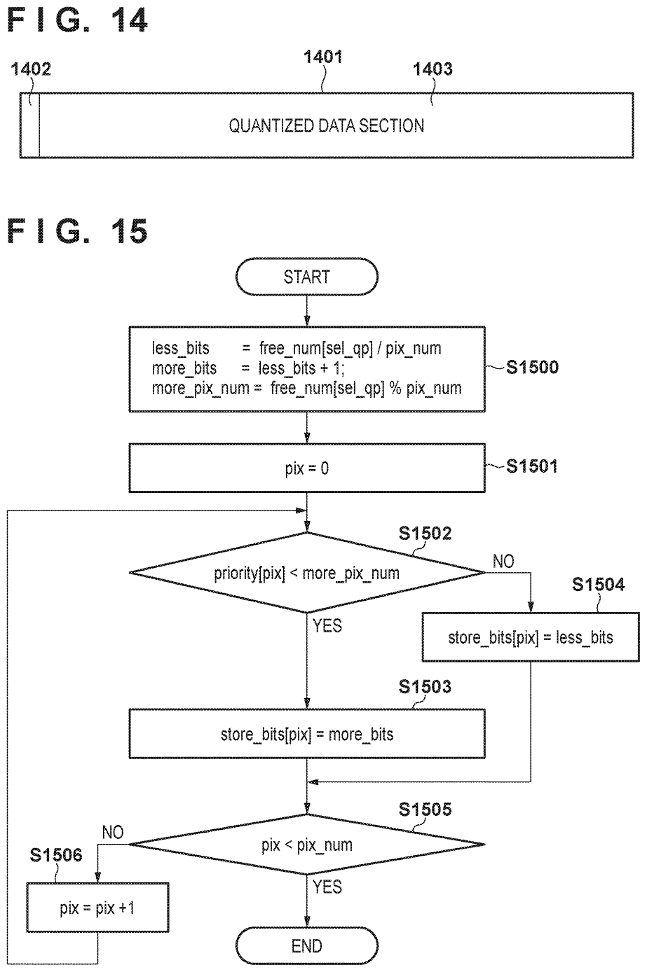

Next, the encoding format in the PCM mode will be described with reference to FIG. 14. In this embodiment, the size of an encoding block 1401 is 144 bits, which is the target code size, as in the DPCM mode.

The encoding block 1401 includes an encoding mode flag 1402 (1 bit) indicating the encoding mode and a quantized data section 1403 (143 bits). The encoding mode flag from the QP determination unit 215 is stored in the encoding mode flag 1402 (1 bit). In this embodiment, the value of the encoding mode flag indicating the PCM mode is assumed to be 1. The quantized data (24 pixels) from the encoding unit 211E is packed bit-by-bit using the code length for each pixel and stored in the quantized data section 1403. In this embodiment, the QP in the PCM mode is 4, however, as described above, one pixel in the encoding block is quantized at QP=5, by increasing the QP by 1. Therefore, 23 of the 24 pixels are quantized to 6 bits per pixel, and one pixel is quantized to 5 bits. Therefore, a total of 23×6+5=143 bits of quantized data is stored in the quantized data section 1403.

In this way, the coded data multiplexed in accordance with the encoding mode for each encoding block is output as stream data to the output terminal 202 and input to the memory 30.

As described above, in this embodiment, if the code size obtained by pixel-by-pixel encoding of one encoding block is less than the target code size, the image encoding unit 20 stores the bits lost during quantization in free space based on a randomly set priority. As a result, the quantization error is distributed throughout the encoding blocks without being concentrated in a specific location, reducing the appearance of unnatural stripes in the decoded image due to the encoding error.

### Image Decoding Unit 40

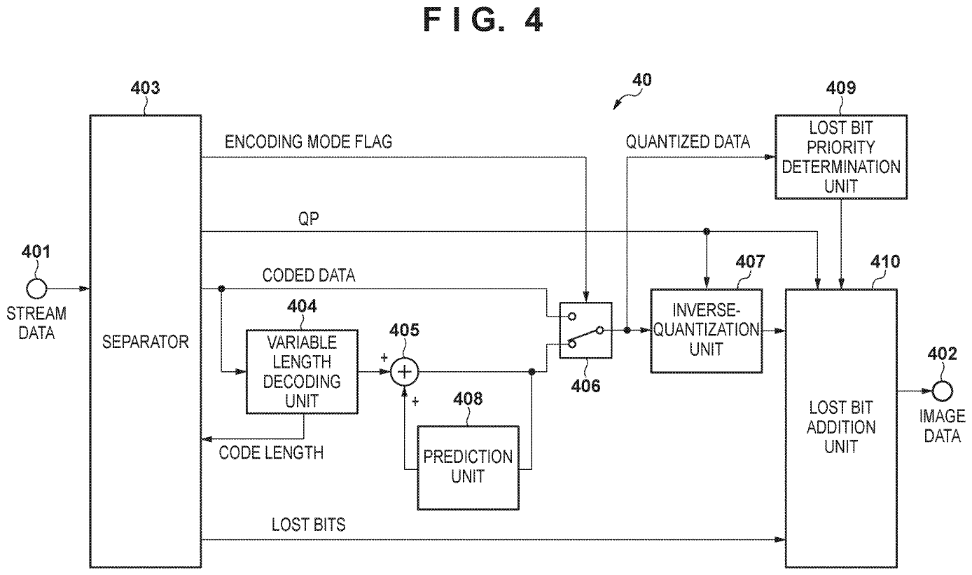

Next, referring to FIG. 4, the configuration and operation of the image decoding unit 40, which decodes coded data generated by the image encoding unit 20, will be explained.

FIG. 4 is a block diagram illustrating the detailed configuration of the image decoding unit 40. The image decoding unit 40 can decode coded data stored in the memory 30.

The image decoding unit 40 shown in FIG. 4 includes a separator 403, a variable length decoding unit 404, an adder 405, a selector 406, an inverse-quantization unit 407, a prediction unit 408, a lost bit priority determination unit 409, and a lost bit addition unit 410. The image decoding unit 40 may be configured as integrated hardware including a dedicated device, a logic circuit, a memory, etc., or may be configured as a distributed system including multiple devices, etc. Alternatively, the image decoding unit 40 may be realized by a memory, a processing program stored in the memory, and a computer such as a CPU that executes a processing program.

The coded data generated by the image encoding unit 20 and temporarily stored in the memory 30 is input for each encoding block to the separator 403 via an input terminal 401. Hereinafter, the coded data for each encoding block will be referred to as “stream data.”

The separator 403 separates the input stream data into the encoding mode flag stored at the beginning of the input stream data, QP, coded data, and lost bits, and outputs them sequentially for each processing cycle.

The separator 403 outputs the coded data (quantized data in the PCM mode) to the variable length decoding unit 404 and the selector 406. In the DPCM mode, the variable length decoding unit 404 performs variable-length decoding on the input coded data, outputs the decoded data to the adder 405, and outputs the code length of the code at that time to the separator 403. The separator 403 accumulates the code length until the variable length decoding unit 404 has variable-length decoded the coded data for 24 pixels contained in one encoding block. The separator 403 then subtracts the accumulated value from the fixed length to determine the storage position of the lost bits section in the fixed-length stream data (more precisely, the total size of the lost bit section 1207 and the stuffing section 1208), and outputs the data including the lost bits section to the lost bit addition unit 410.

The adder 405 adds the predicted data from the prediction unit 408 to the decoded data to obtain a decoded value (decoded data), and outputs the decoded value to the selector 406 and the prediction unit 408.

The prediction unit 408 generates predicted data for the current image data using the decoded value from the adder 405. The method for generating predicted data is the same as the method for generating predicted data in the prediction unit 302 of the encoding unit 211 described above.

Depending on the encoding mode flag, the selector 406 selects the coded data from the separator 403 in the PCM mode, and selects the decoded data output from the adder 405 in the DPCM mode, and outputs the selected data as the quantized data to the inverse-quantization unit 407 and the lost bit priority determination unit 409.

The inverse-quantization unit 407 generates inverse-quantized data by inverse-quantizing the quantized data from the selector 406 using the QP input from the separator 403, and outputs the inverse-quantized data to the lost bit addition unit 410. Note that when the encoding mode is the PCM mode, the separator 403 outputs the QP as “4”.

The lost bit priority determination unit 409 has a similar configuration to the lost bit priority determination unit 226 of the main encoding system 220, and determines the priority for determining the number of lost bits stored for each pixel in a similar manner. Therefore, the priority determined here is the same as the priority of the encoding block determined by the lost bit priority determination unit 226 of the main encoding system 220 for each encoding block.

The lost bit addition unit 410 has an internal buffer memory for storing inverse-quantized data and lost bits for an encoding block. The lost bit addition unit 410 then adds the lost bits output from the separator 403 to the inverse-quantized data based on priority to generate decoded image data. The lost bits are added in the same way as the multiplexing unit 223 of the main encoding system 220, and in this embodiment, the non-lost bit portion of FIG. 13B is added.

Here, a specific example of the lost bit addition processing by the lost bit addition unit 410 will be described. Assume that the pixel to be decoded is the first pixel in FIG. 13B. The most significant 7 bits of the 10 bits have been obtained by inverse-quantization. Based on the priority from the lost bit priority determination unit 409 and using a method similar to that of the multiplexing unit 223 of the main encoding system 220, the lost bit addition unit 410 determines to add 2 bits to the corresponding pixel. The lost bit addition unit 410 reads the corresponding 2 bits from the buffer and fills them into the upper 2 bits (bit 2, bit 1) that are dominant relative to the lost bit count “3” of the pixel of interest. The lost bit addition unit 410 also fills in bit 0, the least significant bit that cannot be filled, with a preset value (e.g., “0”). This allows the lost bit addition unit 410 to decode the 10-bit pixel data of the pixel of interest. The lost bit addition unit 410 outputs 10-bit data representing the pixel of interest after the addition to the output terminal 402.

The image encoding unit 20 may perform main encoding using the main encoding system 220 without performing preliminary encoding using the preliminary encoding system 210. In this case, the encoding unit 211E of the main encoding system 220 may perform quantization according to, for example, predetermined quantization parameters. When quantization according to predetermined quantization parameters is performed, the image decoding unit 40 may also perform inverse-quantization according to the same quantization parameters.

As described above, according to the first embodiment, by randomly allocating the number of lost bits to be stored to pixels within an encoding block, it is possible to make noise in low-brightness parts of an image that occurs during encoding and decoding of the image less noticeable.

In this embodiment, the preliminary encoding system 210 has four encoding units 211A to 211D, each of which performs encoding in the DPCM mode with QP=0, 1, 2, or 3. If the target code size is exceeded even with QP=3, the main encoding system 220 performs encoding in the PCM mode with QP=4. However, encoding in the PCM mode is not necessarily required. For example, let the bit depth per pixel be M, and the target code size per encoding block be Ctarget, and it is assumed that the QP value for ensuring that the total code size per encoding block in the DPCM mode is equal to or less than the target code size in the worst case scenario is “N” (N<M−1). Then, if coded data in the DPCM mode with QP=N is acceptable as final data, the preliminary encoding system 210 would have N+1 encoding units with QP=0 to N. The QP determination unit 215 then determines the code size for each of the N+1 encoders and determines the largest QP that makes the total code size for one encoding block equal to or smaller than the target code size Ctarget as the QP to be employed. The main encoding system 220 then performs encoding in the DPCM mode according to the determined QP to be employed.

Furthermore, in the present disclosure, the number of encoding units 211 may be changed depending on the desired compression ratio. For example, if the bit depth of each pixel data is M and the compression ratio is D/M, (M−D) encoding units may be provided, each of which may be set to a QP of 0 to (M−D−1). Furthermore, the QP does not have to be a continuous value; for example, a discrete value equal to or less than (M−D−1), such as 0, 2, 4, etc., may be used, and a configuration using fewer than (M−D) encoding units may be used.

Conversely, if the compression rate is variable, and the number of provided encoding units 211 is fixed and is greater than the number of encoding units 211 required to change the QP value by 1 at the desired compression rate, control may be performed to use some of the provided encoding units 211. Furthermore, if the number of encoding units 211 is less than the number required to change the QP value by 1 at the desired compression rate, the QP value may be set discretely.

This embodiment may also be applied to an image capturing apparatus such as a digital camera or video camera. In this case, for example, a control circuit including the image encoding unit 20 is installed on the imaging unit side, and a control circuit including the image decoding unit 40 is installed on the side that receives the image capture results and performs various image processing. As a result, even if the imaging resolution increases, normal communication can be performed without constricting the communication bandwidth between the two control circuits.

### Second Embodiment

Next, a second embodiment of the present disclosure will be described. In this second embodiment, the inverse-quantization processing performed by the inverse-quantization unit 407 of the image decoding unit 40 shown in FIG. 4 will be described. Note that processes except for processes performed by the inverse-quantization unit 407 and the configuration of the image processing apparatus 100 are the same as those described in the first embodiment, and the description thereof will be omitted.

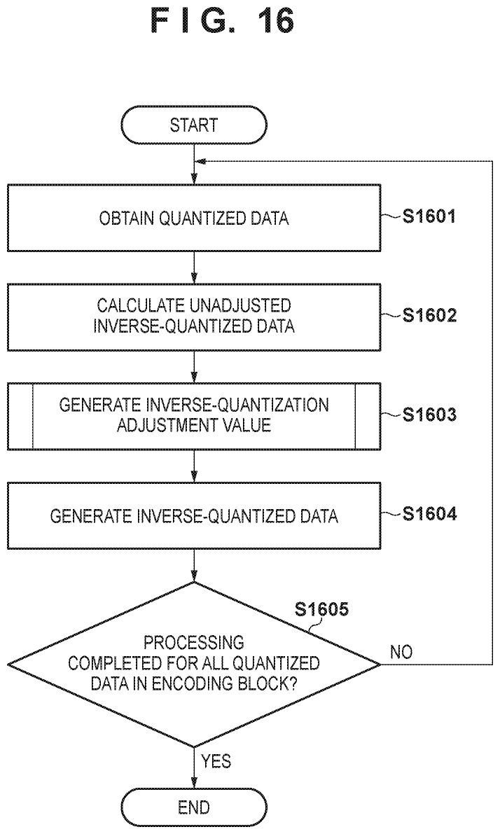

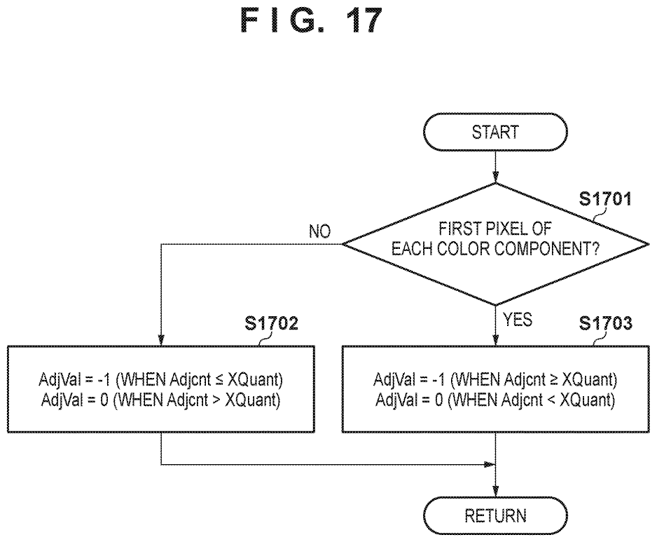

FIGS. 16 and 17 are flowcharts showing the inverse-quantization processing performed by the inverse-quantization unit 407 in the second embodiment.

First, in step S1601, the inverse-quantization unit 407 obtains the first quantized data Quant of the encoding block obtained by decoding the stream data.

Next, in step S1602, the inverse-quantization unit 407 generates unadjusted inverse-quantized data by the calculation expressed by Equation (13).

XQuant=(Quant<<QP)+QS/2 (13)

In Equation (13), << denotes a left shift, XQuant is the unadjusted inverse-quantized data, and QS is the quantization step value, which in this embodiment is equal to 2^{QP}. The QS/2 (1/2 of QS) portion of Equation (13) is specifically referred to as the “inverse-quantization correction value.” While Equation (13) illustrates an example in which the quantized data is left-shifted by QP when generating the unadjusted inverse-quantized data, the quantized data may be multiplied by the quantization step value QS.

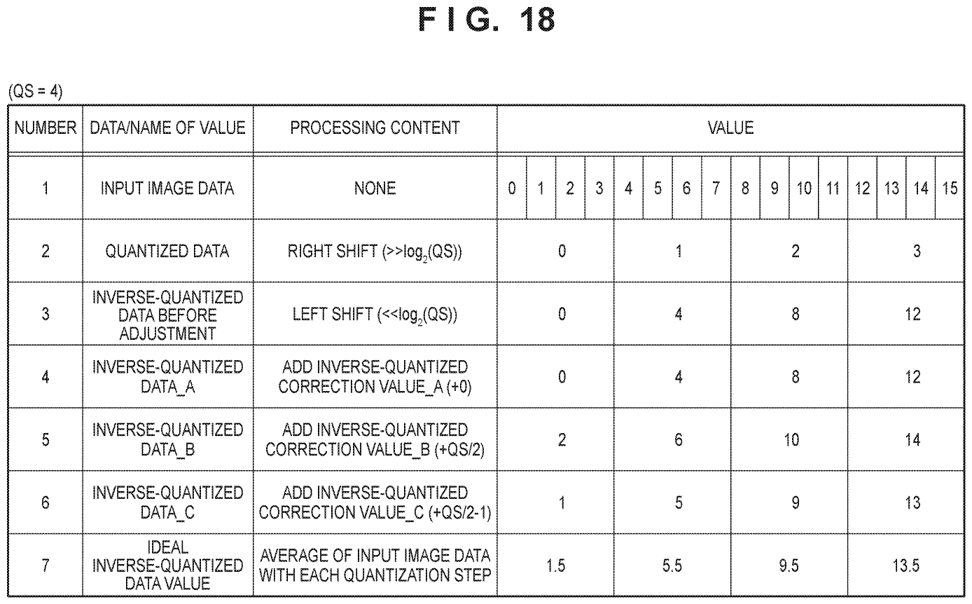

Here, the inverse-quantization correction value will be described with reference to FIG. 18. FIG. 18 shows the difference in the inverse-quantization result due to the difference in the inverse-quantization correction value in an example where QS=4 (i.e., QP=2).

In FIG. 18, “input image data” is a list of image data values before quantization. In this case, for example, in the case of 10 bits, the list shows the range that can be expressed with 4 bits (0 to 15) out of 0 to 1023.

“Quantized data” indicates the value obtained by performing quantization processing on input image data using QS=4 during encoding (right shift by log₂(QS) bits, i.e., right shift by 2 bits). That is, as a result of quantization, input image data 0 to 3 becomes 0, 4 to 7 becomes 1, 8 to 11 becomes 2, and 12 to 15 becomes 3.

“Inverse-quantized data before adjustment” indicates the value obtained by performing inverse-quantization processing before adjustment on the quantized data using QS=4 (left shift by log₂(QS) bit, i.e., left shift by 2 bits). Therefore, the inverse-quantized data before adjustment corresponding to input image data 0 to 3 becomes 0, 4 to 7 becomes 4, 8 to 11 becomes 8, and 12 to 15 becomes 12, all of which are the smallest values among the corresponding input image data.

The “ideal inverse-quantized data value” is the ideal value after inverse-quantization calculated by averaging the input image data corresponding to the quantized data when inverse-quantization is performed on the quantized data. That is, when QS=4, the ideal inverse-quantized data value corresponding to input image data 0 to 3 is (0+1+2+3)/4=1.5. Similarly, the ideal inverse-quantized data value corresponding to input image data 4 to 7 is 5.5, 8 to 11 is 9.5, and 12 to 15 is 13.5, none of which are integer values. Since each value of image data generally takes an integer value, these ideal values cannot be used as is.

Meanwhile, a method of generating inverse-quantized data by adding an inverse-quantization correction value to the inverse-quantized data before adjustment to shift the representative value has been conventionally known. “Inverse-quantized data_A” to “inverse-quantized data_C” show such conventional examples.

Inverse-quantized data_A indicates a value obtained by setting the inverse-quantization correction value to be added to the inverse-quantized data before adjustment to 0 (no correction). As a result, input image data 0 to 3 becomes 0, 4 to 7 becomes 4, 8 to 11 becomes 8, and 12 to 15 becomes 12.

Inverse-quantized data_B indicates a value obtained by setting the inverse-quantization correction value to be added to the inverse-quantized data before adjustment to QS/2 (here, 2). As a result, input image data 0 to 3 becomes 2, 4 to 7 becomes 6, 8 to 11 becomes 10, and 12 to 15 becomes 14.

Inverse-quantized data_C indicates a value obtained by setting the inverse-quantization correction value to be added to the inverse-quantized data before adjustment to QS/2−1 (here, 1). As a result, input image data 0 to 3 becomes 1, 4 to 7 becomes 5, 8 to 11 becomes 9, and 12 to 15 becomes 13.

However, the inverse-quantized data_A, inverse-quantized data_B, and inverse-quantized data_C always differ from the ideal inverse-quantized data value by −1.5, +0.5, and −0.5, respectively. In other words, a bias always occurs in one direction (either the positive or negative side).

Therefore, in this embodiment, in order to suppress the occurrence of such bias, the inverse-quantization unit 407 generates an inverse-quantization adjustment value by the calculation described below, and generates inverse-quantized data by adding this to the inverse-quantized data before adjustment.

In step S1603, the inverse-quantization unit 407 generates an inverse-quantization adjustment value.

FIG. 17 is a flowchart showing the processing of generating an inverse-quantization adjustment value performed in step S1603.

In step S1701, the inverse-quantization unit 407 determines whether the pixel to be processed is the first pixel of each color component of the encoding block (e.g., R0, G0, or B0 in FIG. 5A). If it is the first pixel of each color component, the process proceeds to step S1703; if not, the process proceeds to step S1702.

In step S1702, the inverse-quantization unit 407 generates an inverse-quantization adjustment value by the calculations shown in Equations (14) and (15).

AdjVal=−1 (when Adjcnt≤XQuant) (14)

AdjVal=0 (when Adjcnt>XQuant) (15)

In Equations (14) and (15), AdjVal is the inverse-quantization adjustment value, and Adjcnt is the adjacent pixel data. As shown in Equations (14) and (15), the inverse-quantization adjustment value takes on a value of either 0 or −1.

The adjacent pixel data is the inverse-quantized data before adjustment (XQuant) corresponding to a pixel of the same color adjacent to the pixel to be processed. The adjacent pixel data is generated by delaying the inverse-quantized data before adjustment and appropriately selecting it as inverse-quantized data before adjustment corresponding to the previous pixel of the same color component (i.e., the pixel to the left).

That is, if the quantized data of the pixel to be inverse-quantized is greater than or equal to the inverse-quantized data before adjustment of the previous pixel of the same color component, the inverse-quantization unit 407 generates an inverse-quantization adjustment value of −1, and if it is less, it generates an inverse-quantization adjustment value of 0.

In addition, in step S1703, the inverse-quantization unit 407 generates the inverse-quantization adjustment value by the calculations shown in equations (16) and (17).

AdjVal=−1 (when Adjcnt≥XQuant) (16)

AdjVal=0 (when Adjcnt<XQuant) (17)

For the first three pixels of each color component of an encoding block that have no previous pixel, the inverse-quantized data before adjustment corresponding to the pixel to the right of the same color component (e.g., R1, G1, and B1 in FIG. 5A) may be used as the adjacent pixel data.

Next, in step S1604, the inverse-quantization unit 407 generates inverse-quantized data by adding the inverse-quantization adjustment value to the inverse-quantized data before adjustment.

IQuant=XQuant+AdjVal (18)

In Equation (18), IQuant is the inverse-quantized data. By adding the inverse quantization adjustment value to the inverse-quantized data before adjustment, the inverse quantization correction value effectively becomes either QS/2 or QS/2−1.

Next, in step S1605, the inverse-quantization unit 407 determines whether processing has been completed for all quantized data in the encoding block. If so, the processing ends. If not, the process returns to step S1601 to obtain the next quantized data in the encoding block.

Thereafter, the processes of steps S1601 to S1605 are repeated until they have been performed on all quantized data in the encoding block.

As described above, according to the second embodiment, when decoding coded data, the inverse-quantization adjustment value is selectively switched and used depending on the magnitude relationship with adjacent pixel data, thereby making it possible to prevent bias that is always biased in one direction. Furthermore, for the inverse-quantization adjustment value corresponding to the first three pixels of the encoding block of each color component, the magnitude relationship with adjacent pixel data is reversed from that for the other pixels. As a result, the selection result is the same as for the pixel adjacent to the right of each component, making block boundaries less noticeable.

In the above example, a case has been described in which the inverse-quantization adjustment value is changed depending on the magnitude relationship with adjacent pixel data, but the present disclosure is not limited to this. For example, 0 and −1 may be assigned alternately depending on pixel position. For example, 0 may be selected for pixels at even-numbered positions, and −1 may be selected for pixels at odd-numbered positions. This simplifies the circuit configuration, and is therefore effective in cases where the circuit cost requirements in a device to which the disclosure is applied are strict. Alternatively, 0 and −1 may be assigned randomly.

In the above description, the coded data encoded by the image encoding unit 20 of the first embodiment is decoded, but the second embodiment is not limited to this. The image decoding unit 40 described in the second embodiment can decode coded data encoded in the PCM mode or the DPDM mode. In this case, the lost bit priority determination unit 409 and the lost bit addition unit 410 can be omitted, and the output from the inverse-quantization unit 407 can be output as image data without adjustment.

### Other Embodiments

The present disclosure may be applied to a system consisting of a plurality of devices, or to a device consisting of a single device.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-059132, filed Mar. 31, 2025, and 2025-059133, filed Mar. 31, 2025 which are hereby incorporated by reference herein in their entirety.

What is claimed is:

1. An image encoding apparatus that encodes image data for each block composed of a predetermined number of pixels, generates coded data having a preset target code size, and outputs the coded data, the apparatus comprising one or more processors and/or circuitry which function as:
an acquisition unit that acquires image data;
an encoding unit that encodes, for each block, the image data acquired by the acquisition unit such that a block code length of coded data for each block obtained through the encoding is equal to or less than the target code size;
a determination unit that randomly determines priorities of the pixels constituting each block; and
an addition unit that, in a case where the block code length of each block generated by the encoding unit is less than the target code size, adds to the coded data, a lost bit or bits of each pixel that were lost through the encoding, in order from the pixel with a highest priority and without exceeding the target code size.

2. The image encoding apparatus according to claim 1, wherein the encoding performed by the encoding unit includes processing for quantizing the image data, and
the lost bit or bits are bits of each pixel that are lost through the quantization.

3. The image encoding apparatus according to claim 1, wherein the addition unit obtains, for each block, a difference between the target code size and the block code length, and determines, for each pixel, the number of lost bit or bits to be added to the coded data based on a quotient and a remainder obtained by dividing the difference by the number of pixels constituting the block, and on the priorities.

4. The image encoding apparatus according to claim 3, wherein the addition unit increases, by one bit, the number of lost bit or bits to be added to the coded data of a pixel whose priority is higher than the remainder, compared with a pixel whose priority is lower than the remainder.

5. The image encoding apparatus according to claim 1, wherein the determination unit includes a random value generation unit that generates random values, and determines the priority using the generated random values.

6. The image encoding apparatus according to claim 2, wherein the determination unit includes a random value generation unit that generates random values, generates a seed value for use by the random value generation unit using part or all of quantized data obtained by the quantization, and determines the priorities using random values generated using the seed value.

7. The image encoding apparatus according to claim 6, wherein the determination unit generates the seed value having a number of bits corresponding to the number of pixels constituting the block by performing a predetermined logical operation on the quantized data.

8. The image encoding apparatus according to claim 5, wherein the determination unit replaces the random value corresponding to the first pixel of each block with zero.

9. The image encoding apparatus according to claim 5, wherein the determination unit determines the priorities by inverting part or all of the bits of the generated random values.

10. The image encoding apparatus according to claim 6, wherein the determination unit determines the priorities by adding the seed value to the generated random values.

11. The image encoding apparatus according to claim 5, wherein the random value generation unit is a random value generation circuit using a linear feedback shift register.

12. The image encoding apparatus according to claim 1, wherein the determination unit determines different priorities for each block.

13. The image encoding apparatus according to claim 1, wherein the determination unit holds, as a table, a priority pattern indicating predetermined random priorities, and determines the priorities in accordance with the priority pattern.

14. The image encoding apparatus according to claim 1, wherein the encoding unit quantizes pixel data of each pixel included in each block, and performs variable-length encoding on quantized data obtained by the quantization.

15. The image encoding apparatus according to claim 1, wherein
the encoding unit includes:
a first encoding unit that quantizes each pixel included in each block and performs variable-length encoding on quantized data obtained by the quantization; and
a second encoding unit that quantizes each pixel included in each block and outputs quantized data obtained by the quantization as coded data, and
generates the coded data by using either the first encoding unit or the second encoding unit.

16. The image encoding apparatus according to claim 1, wherein the target code size is determined based on a data size of image data of each block and a compression ratio.

17. An image decoding apparatus that decodes, for each block, coded data generated by an image encoding apparatus that encodes image data for each block composed of a predetermined number of pixels, generates coded data having a preset target code size, and outputs the coded data, the apparatus comprising one or more processors and/or circuitry which function as: an acquisition unit that acquires image data; an encoding unit that encodes, for each block, the image data acquired by the acquisition unit such that a block code length of coded data for each block obtained through the encoding is equal to or less than the target code size; a determination unit that randomly determines priorities of the pixels constituting each block; and an addition unit that, in a case where the block code length of each block generated by the encoding unit is less than the target code size, adds to the coded data, in order from the pixel with a highest priority and without exceeding the target code size, a lost bit or bits of each pixel that were lost through the encoding, the image decoding apparatus comprising one or more processors and/or circuitry which function as:
a second acquisition unit that acquires the coded data of each block;
a decoding unit that decodes the coded data of each block acquired by the acquisition unit and generate decoded data;
a determination unit that determines storage positions of the lost bit or bits in the coded data of each block, based on a result of decoding by the decoding unit;
a determination unit that randomly determines priorities of the pixels constituting each block; and
an addition unit that, based on the priorities determined by the determination unit, adds to the decoded data the lost bit or bits acquired from the storage positions determined by the determination unit, and outputs a result as pixel data.

18. An image encoding method that encodes image data for each block composed of a predetermined number of pixels, generates coded data having a preset target code size, and outputs the coded data, the method comprising:
acquiring image data;
encoding, for each block, the acquired image data such that a block code length of the coded data of each block obtained through the encoding is equal to or less than the target code size;
randomly determining priorities of the pixels constituting each block; and
in a case where the block code length of each block generated through the encoding is less than the target code size, adding, to the coded data, a lost bit or bits of each pixel that were lost through the encoding, in order from the pixel with a highest priority and without exceeding the target code size.

19. An image decoding method that decodes, for each block, coded data generated by an image encoding method that encodes image data for each block composed of a predetermined number of pixels, generates coded data having a preset target code size, and outputs the coded data, the method comprising: acquiring image data; encoding, for each block, the acquired image data such that a block code length of the coded data of each block obtained through the encoding is equal to or less than the target code size;
randomly determining priorities of the pixels constituting each block; and in a case where the block code length of each block generated through the encoding is less than the target code size, adding, to the coded data, a lost bit or bits of each pixel that were lost through the encoding, in order from the pixel with a highest priority and without exceeding the target code size, the method comprising:
acquiring the coded data of each block;
decoding the acquired coded data of each block and generating decoded data;
determining, based on a result of the decoding, storage positions of the lost bit or bits in the coded data of each block;
randomly determining priorities of the pixels constituting each block; and
adding, based on the determined priorities, to the decoded data, the lost bit or bits acquired from the determined storage positions, and outputting a result as pixel data.

20. A non-transitory computer-readable storage medium, the storage medium storing a program that is executable by the computer, wherein the program includes program code for causing the computer to function as an image encoding apparatus that encodes image data for each block composed of a predetermined number of pixels, generates coded data having a preset target code size, and outputs the coded data, the apparatus comprising:
an acquisition unit that acquires image data;
an encoding unit that encodes, for each block, the image data acquired by the acquisition unit such that a block code length of coded data for each block obtained through the encoding is equal to or less than the target code size;
a determination unit that randomly determines priorities of the pixels constituting each block; and
an addition unit that, in a case where the block code length of each block generated by the encoding unit is less than the target code size, adds to the coded data, a lost bit or bits of each pixel that were lost through the encoding, in order from the pixel with a highest priority and without exceeding the target code size.
